(19) United States
(12) Patent Application Publication
(10) Pub. No.: US 2002/0178270 A1
(43) Pub. Date: Nov. 28, 2002

(54) Communications services controller

(76) Inventor: John Fitzgerald Riordan, County Kerry (IE)

Correspondence Address: BIRCH STEWART KOLASCH & BIRCH, PO BOX 747, FALLS CHURCH, VA, 22040-0747, US

(21) Appl. No.: 09/976,109

(22) Filed: Oct. 15, 2001

(30) Foreign Application Priority Data
Apr. 12, 2001 (IE) 2001/0360

(51) Int. Cl. G06F 15/173; G06F 15/16

(52) U.S. Cl. 709/229; 709/225; 709/203

(57) ABSTRACT

A communications services controller (2) which is for a number of communication systems connected to a network resource (3). There are user devices (35) connected to the network resource (3). A roles and privileges logic controller (15) controls the use and access to the communications systems in accordance with various rules. There are three functional layers to the invention. Firstly, there is a user directory and contacts layer which the user uses to access the communications systems—phone video conferencing databases etc. Then there is a business layer provided by the privileges logic controller (15) and finally a user interface layer to facilitate the actual communications.

### FIELD OF THE INVENTION

The present invention relates to a communications services controller for a communications network comprising a plurality of communications systems connected to a network resource; a plurality of user devices connected to the services controller, the user devices having a capability to use at least one of the communications systems; a plurality of contact devices connected to the network resource and having a capability to use at least one of the communications systems, some of the contact devices being additionally user devices.

Throughout the world, there is a continuing growth of small to medium size enterprises and an even greater growth in the proportion of such SMEs using internet provider services as part of their day to day working. Broadband delivered services are enabling SMEs to become more competitive and to be able to depend on internet provider services as part of their business critical activities. There is a similar need in the enterprise or corporate type organisation. Indeed, the present invention is of equal relevance to this market. The number, complexity and indeed usefulness of these services is also increasing. This becomes a considerable problem for the user. For each communications service the user needs to have the knowledge of how to use that device, as well as knowledge of how that service identifies the targeted contact. The complexity is increasing all the time, not alone by virtue of the number of devices but also by their inherent complexity. This is having two serious effects. Firstly, for the individual user, it is becoming increasingly difficult to use such devices in a co-ordinated manner and then for the corporate entity, it is becoming more and more complex and difficult to control the usage of such devices within their organisation. As the types of communications become more complex, they also become more expensive and further, as the number of services available from ISPs become more complex and useful, employees of large organisations are increasingly using them. Unfortunately, the usage of such devices and services can lead to an exceedingly large cost for the organisation. Thus, the organisation wishes to control and manage the usage, not alone of the communications devices per se or the communications systems, but also of services provided by such communications systems. Additionally, it desires that its employees will use such communications systems as efficiently as possible and within their authority.

It has been appreciated that there is a need to focus on providing products and services that are enabled by broadband connectivity which is becoming available in the small and medium enterprise market. Essentially, it is suggested by experts that over the next five years, the major areas in which rapid applications growth will occur, are in the communications applications and services, business systems particularly in the SME market and internet access services facilitated by IP (Internet Protocol) broadband technology. It is also predicted that these technologies are converging at an increasingly rapid rate, although what is required and it is appreciated by many, is a customer needs centric service that takes advantage of this convergence. Further, factors increasing the need for such a service is that teleworking is growing across Europe and in many other countries. It has been suggested that up to 60 million SMEs in Europe are underserved by internet providers. A further major problem for the telecoms market is that there has been a dramatic change across it in which there is increasing levelling of the various service offerings such as bandwidth, access, ecommerce, email support, and so on. There has been an enormous price competition between the telecoms providers and further, more disturbing for the telecoms providers, a considerable lack of brand awareness on the part of the users. These communications services providers recognise the need to differentiate themselves from the marketplace by adding value solutions which enable the end user to identify with the brand that is providing the solution and build brand loyalty. The end user should derive cost savings through the use of these systems with reduced costs of use, increases in productivity due to the use of the converged communications environment and also to have available to them, the services that will make their operations more efficient.

As remarked above, a major problem is the number of disparate technologies, the need to be able to communicate with any contact from a multitude of access or user devices including, for example, mobile phones, the PC, phone and a PDA, and so on.

There is a considerable need for the user to communicate with and manage their normal communications more efficiently, effective and simply, than is possible at the present moment. Again, for the business organisation, as mentioned above, there is a need to increase productivity, enhance the business process, and improve generally the productivity of their workforce. Everybody is aware that improved communications are one of the major ways in which companies can operate more efficiently. As well as improved communications, there is also the need by the corporate entity to ensure that those communications are operated and used in the most efficient way possible.

### SUMMARY OF THE INVENTION

The present invention relates to a communications services controller for a communication network. A communication network generally comprises a number of communications systems connected to some form of network resource. The communications services controller has connected to it a number of user devices, each of which have a capability to use at least one of the communications systems such as simple voice telephone, video conferencing and so on. A number of contact devices are also connected to the network resource and have a capability to use at least one of the communications systems. Obviously, some of the contact devices are additionally user devices.

In accordance with the invention, the services controller comprises a first element of a user directory which comprises a user identifier and data on all communications systems available to the user including a unique identifier for each communications system and access data to allow the user device access the available communications systems. Thus, the user directory contains all the information to allow the user use the services available. There is also provided a roles and privileges logic controller which comprises means for controlling access to a desired communications system on a user requesting to use the communications system. The roles and privileges logic controller has means for storing access rules based on the roles and privileges allocated to the particular user and further has means to provide access based on the said access rules. There is also provided a contacts directory comprising a contacts identifier, data on each communications system available to the contact device, including a unique identifier for each communications system available to the contact device for use in the managed network resource.

Finally, there is an intercommunications server which has means for contacting and opening communications using one of the communications systems connected to the network resource between a user device and a contacts device on receiving an access permitted signal. The intercommunications server has means to obtain the necessary access data for the user device from the user directory and for the contact device from the contacts directory. Essentially, therefore, the invention allows the user to contact the server and it is not the user that contacts with a particular communications device but it is the server which interacts with them. Effectively, the user interacts with their own contacts list as the first action in initiating communication.

At present, for normal communications, the user chooses the system and then has to operate the particular communications system in accordance with the rules for the communications system required to effect the necessary communication. With the present invention, the user chooses who and then the system takes over as to how and all the ancillary processes are then carried out by the system.

Ideally, the intercommunications server comprises means for allowing a user device access more than one communications system simultaneously for contact with the one contact device or for contact with another contact device while communicating with a different contact device.

One of the principal features of the present invention is the roles and privileges logic controller which comprises means for storing a record of the access to a communications system obtained by a user during a preset period. Further, the roles and privileges logic controller has means for defining a privilege as an access rule to a specified communications system or to a specified service provided on a specified communications system. This can be one or more privileges and further it has menas to allocate at least on privilege to each user.

These privileges can be many such as the total duration of use within a specified time period, usage between specified times during the day, monetary limits over the specified time limit, incoming use only, user device limitation, the number of users already provided with the privilege, communications system traffic handling capabilities, priority of access with respect to other users, and the nature of the contact which it is desired to communicate with. However, it is important to appreciate that these are only some of the various privileges and rules and they will depend entirely on management requirements when it is used in large organisations.

In one embodiment of the invention, there is provided a conferencing server having means to allow a user device contact the server and further, ideally, the server is capable of aggregating the data to and from each user device to provide a single incoming and outgoing data stream independent of the number of users.

The invention further provides a closed messaging device for the reception and storage of messages for nominated user devices which messaging device may also have means to receive and store messages from disparate messaging services. Further, a unified messaging server may be provided having means for storing store-forward-messaging services which could comprise one or more of:- email; voicemail; fax received and SMS messages.

In another aspect of the invention, the controller comprises means to allow users access to view a document, edit the document and to store changes in the document due to editing which changes are identified by the particular user who carried out the editing. Many forms of network resource may be used such as the internet, the extranet or the intranet. The roles and privileges logic controller may include means to provide an access permitted signal and an access denied signal.

It is very important to appreciate that certain functions of the system will be set up previous to use and thus the invention provides a method of allocating and storing a user identifier for each user and then collecting and storing data on each communications system available to the user. There will obviously be no point in storing data in relation to a particular communications system if the user has not got the specific communications system available to him or her. Then, there is preferably connected and stored access data to allow the user device operated by a user access each available communications system. Then, various terms and conditions under which access to each communications system is permitted is allocated and stored for each user by means of privileges rules. To enable a user to identify contacts, contact identifiers are thus allocated and stored in respect of each contact. As well as storing a contact identifier for each contact, it is necessary to collect and store access data to allow a user device access the contact on a contact device. Obviously, there is no point in a user having the ability to use the particular device to contact somebody such as video conferencing if the person being contacted does not have video conferencing available to them. Finally, when all this data is provided and stored, then on a user requesting access to a contact, the privileges rules are consulted and on access to the communications system being permitted, the system retrieves the contact access data and uses the access data to connect the user device to the contact device. Thus, the user merely has to look for the contact and it is provided once the user is permitted to do so and the contact device is able to be contacted on the desired communications device. Obviously, if this access to allow the user device to communicate with the contact is not available, the user first collects the necessary access data for storage.

It will be appreciated that the user device can be connected to the contact device by more than one communications system or indeed the user device can be connected to two different contact devices.

Ideally, a record of the access to a communications system obtained by a user during a preset period is stored. This allows management to track the usage of various communications system in a commercial organisation.

As already explained above, the method would include any of the privileges as described in relation to the rules and privileges controller.

Further, it is envisaged that the invention can be carried out by a computer program comprising program instructions for causing a computer to perform the method as laid out above or indeed a computer program forming the means to allow the controller, as described above, perform the various functions. These computer programs can be embodied on a record medium, stored in computer memory, embodied in a read only memory or indeed carried on an electrical signal carrier.

### BRIEF DESCRIPTION OF THE DRAWINGS

The invention will be more clearly understood from the following description of an embodiment thereof, given by way of example only, with reference to the accompanying drawings, in which:

FIG. 1 is a diagrammatic view of a communications system incorporating a communications services controller according to the present invention,

FIG. 2 is a view of FIG. 1 showing the functionality of the implementation of the invention,

FIG. 3 is a view showing the operation of the invention,

FIG. 4 is another representation of the functional aspects of the server according to the invention, and

FIGS. 5 and 6 are simplified flowcharts of one way of carrying out the invention.

### DETAILED DESCRIPTION OF THE PREFERRED EMBODIMENTS

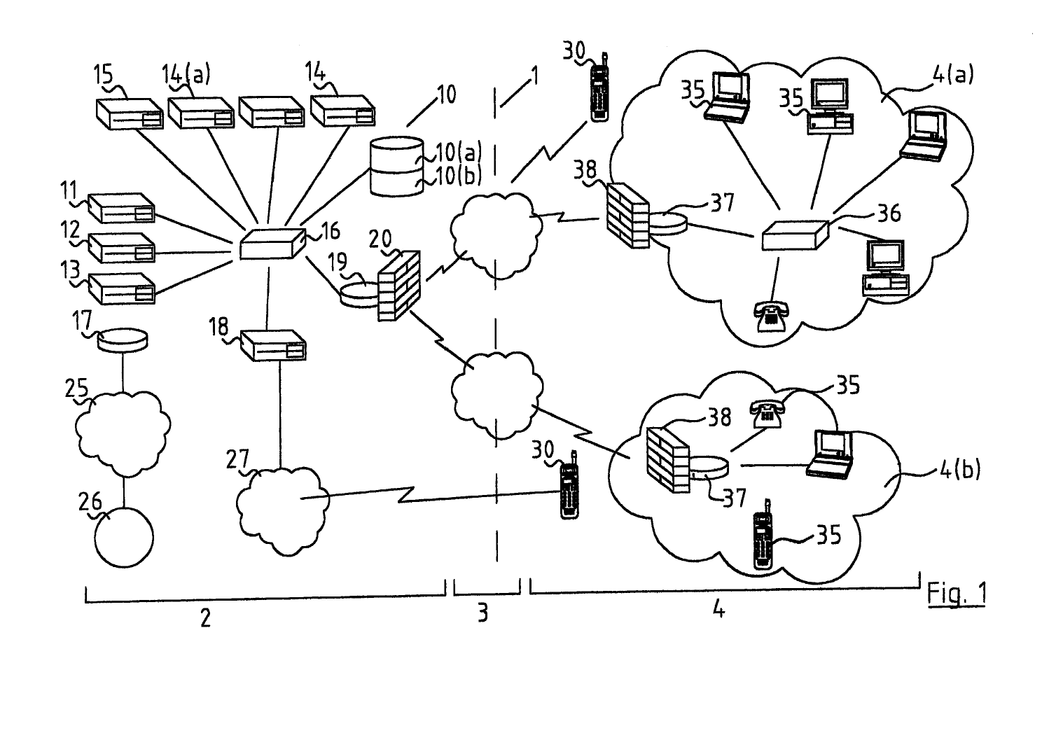

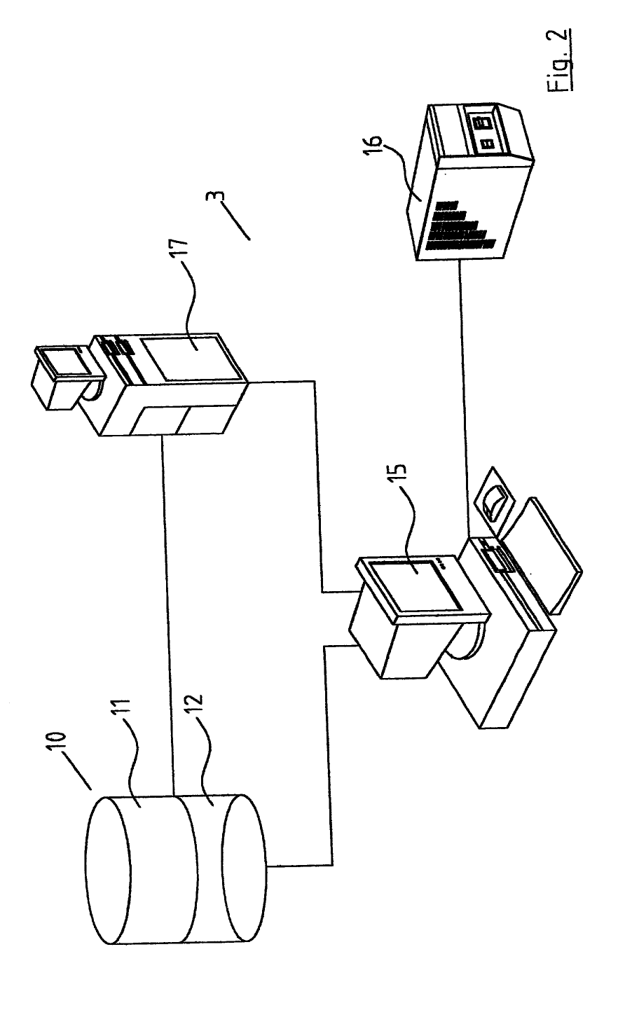

One of the major problems in describing the present invention in relation to the drawings is that to a certain extent the drawings and diagrams combine logical and physical concepts. Thus while FIGS. 1 and 2 show the physical aspects of the invention in particular. FIG. 2 shows the physical aspects of the invention as described in FIG. 1 in functional terms.

Referring now to FIG. 1, there is illustrated a communications network according to the invention illustrated generally by the . Essentially, as can be seen from FIG. 1, there are three major components. There is the actual hosting centre or Iport server 2, the physical network resource 3 and the end points or end users 4. This network resource 3 , in turn, will allow communication between the various users 4 and third parties namely external organisations and individuals who are not directly customers or users of the actual communication system, though they will be contacted by the system: thus they are users of the system. The Iport server 2 comprises a database storage device 10 which stores two databases, namely, a user directory 10(a) and a contacts directory 10(b). Various other Iport databases store information relevant to specific system functions, but there is no need at this stage to specify beyond the logical functionality of the storage of user information and contact information.

The Iport server 2 also includes various other subservers as it were, for example, and these are shown for illustrative purposes only, a call processing server 11, a unified messaging server 12, and a conferencing server 13. Indeed there can be other servers used. Some of these additional servers are identified by the reference numeral 14 and subscript letters where necessary. Further, the server 2 includes an application server 15. The database storage device and the various servers 11, 12, 13, 14 and 15 are all connected to a switch 16, which is in turn connected to an internet router 17, a voiceover gateway 18 and router 19, which incorporates a firewall 20, which then communicates with the various physical network resources 3.

One of the servers 14, namely, the server 14(a) is an intercommunications server which has means for contacting and opening communications using a communications system connected to the network resource 2. The communications system will be between a user device and a contacts device. It is important to appreciate in this specification that there is a distinction between a user device and a contacts device which is, to a certain extent, artificial, since a user device could be a contact device. What must be appreciated is that users of the system are referred to as users, thus, for example, a telephone operated by somebody connected to the system and forming part of the system is referred to as a user device. An identical telephone used by somebody to whom a user of the system wishes to communicate but which third party being addressed is not a user of the system. Then, that telephone or that device is called a contact device. It will be appreciated that in certain instances, some of the contact devices can additionally be user devices. This would arise for example, when the user device is also contacting another user of the system.

The internet router 17 communicates with the internet 25 which in turn connects to various service providers 26. The voiceover gateway 18 communicates with a Public Switch Telephony Network (PSTN) 27 which can, in turn, connect to various other communications or contact devices 30 which do not form part of the communications system and are essentially external communication devices and could be PCs etc These are the devices used by the third parties referred to above. Some of the contact devices 30 could also be effectively user devices 35, depending on the circumstances.

Many contact devices 30 could be used but only one in the form of a mobile phone is illustrated.

The physical network resource 3 comprises PSTN, SDN, wireless, DSL etc. and is not limited in any way.

The users of the communications system could be corporate users, tele-workers, SMEs, home users, workers operating remotely form their corporate base, indeed anyone with a connection to a communications network.

For example, there is illustrated a corporate/SME user 4(a) having a plurality of user devices 35 which are not distinguished from each other but could, for example, be PCs, PCs with video cameras, simple telephones and so on, all connected to a central switch 36 which is in turn connected to a router 37, having a firewall 38, which again connects with the physical network resource 3. There is also shown a remotely positioned client or user 4(b), obviously smaller than a corporate or SME client which have essentially input user devices 35 connected again to a central switch 36 and to a router 37.

Referring now to FIG. 2, this is shown functionally the various services that could be provided by the physical devices. FIG. 2 does not require any further explanation. In the embodiment described above, the database storage device has been stated to comprise of two databases, namely a user directory and a contacts directory. Almost certainly in most cases, it will be the one corporate directory and that the two will in fact be combined. However, for ease of understanding of the invention it is advantageous to separate them into different units.

The applications server 15 is in its function a roles and privileges logic controller and the reference numeral 15 is also used when referring to this controller and comprises means for controlling access to any desired communication on a user requested use of the communication system. Needless to say, the communication services controller can only control access to communication systems with which it has been integrated. The applications server 15 has a memory, including a unique identifier for each physical communications device which makes functionality e.g. video conferencing, email etc available to the particular contact device.

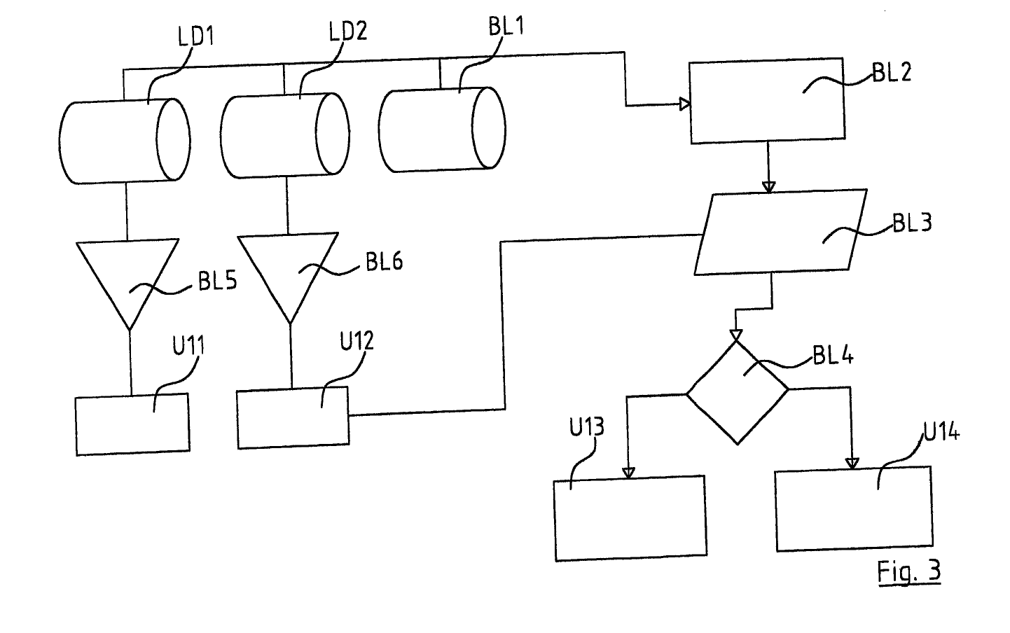

FIG. 3 illustrates functionally the manner in which communications between parties are carried out and in particular how the communications services controller uses information about users and contacts in order to deliver and control the communication resources of the Iport server users, that is to say of the users 4 when they are dealing either with other Iport users 4 as contacts or with external contacts 30 i.e. third parties. To avoid confusion, an alphanumeric form of identification is used in FIG. 3.

For a clear understanding of the invention, it is important to appreciate that it is not the user which interacts with a communication device, it is the collection of user properties within the server 2 which interacts with them. These properties are partly controlled by the user, such as names, addresses, telephone numbers etc. and partly by the system administrator which controls the roles and privileges entered into the roles and privileges logic controller applications server 15. This control could be the ability to call an international phone number, the ability to use video conferencing in certain hours, that is to say the privileges and uses of the communications device that are available to the user. For example, the roles and privileges logic controller, that is to say effectively the system administrator who operates and inputs it, may have a general restriction against everybody messaging particular users.

There are essentially three layers of the invention from a functional viewpoint. They are: firstly the directory layer; then the business logic layer and finally the user interface layer. The directory layer comprises a user directory LD1 and a user contacts directory LD2, which, while shown as separate structures as mentioned already, are more likely in practice to be the one structure. Since they are effectively two separate but related processes, it is preferable to separate them because they perform different functions.

The business logic layer comprises a rules database created by the business administrator, namely, BL1. This rules database exists logically and is described thus in order to promote understanding of the function of the business logic feature set. It does not mean that there is a separate database of rules. The rules database BL1 stores extended data about users. It is controlled by the administrator of the system, effectively the management of a user organisation and contains the type of information as described above, namely, the privileges permitted to the particular user. This is in turn connected to an events manager BL2, which is essentially a process which compares the rules in BL to the user in the user directory LD1 and the contact in the contacts directory LD2 in order to generate a dynamic rule reference collection BL3, which in turn connects to BL4 which is an analysis of rights routine. The business logic layer also operates by identifying the user in the business logic layer BL5 and identifying the contact in the business logic layer BL6.

The user interface layer, which is the third layer, comprises the UI1 layer, where the user logs in, the UI2 layer where the user requests resource to communicate with a contact and then the UI3 layer where the user is allowed enter into a communications session and the UI4 layer where access is denied.

Essentially the events manager BL2 is a process that compares the rules in BL1 to the user in LD1 and the contact in LD2 in order to generate the dynamic rule reference BL3. This is a constantly updated data collection which forms the central and only reference pool to which the system refers to in making decisions about resource availability and policy. At the user end, the business logic layer operates between the user interface to administer processes such as the log in and contact. The central process performed by the business logic layer then comes into effect whereby the communications session initiates a request. For example, asking the system to phone somebody is sent to the dynamic rule reference BL3 and this reacts by going to the analysis rights routine BL4 which returns either a yes or a no and acts accordingly.

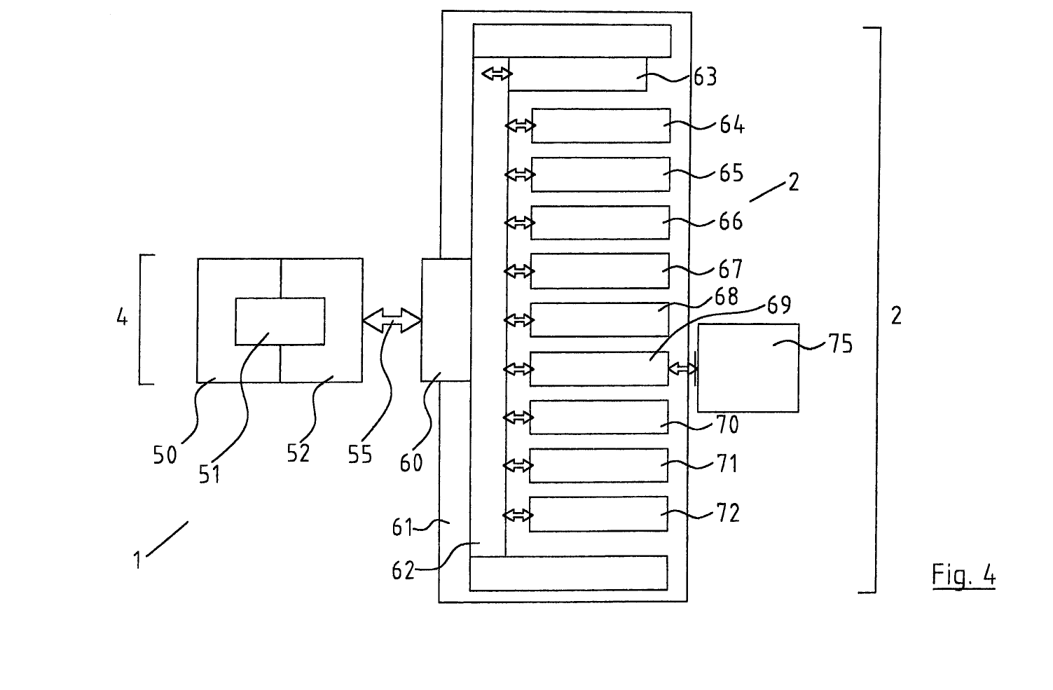

Referring to FIG. 4 there is illustrated a conceptual or logical overview in diagrammatic form of the communications services controller, again indicated generally by the reference numeral 1, split into its two main physical areas of functionality, mainly the client or user side that is to say, the user's 4 side and the Iport server side 2. For simplicity these have been identified by the reference numerals 2 and 4 as above However, the remainder of the functions are identified by new reference numerals to avoid confusion, as some of the functions and physical devices are now described somewhat differently.

On the client or user side 4 there is provided components which must exist in order to enable client functionality to work with the server 2. These components may already be in existence in the client or users site as part of the default set up of the device. In situations, where the client or user devices, namely the plurality of user devices 35 of FIG. 1, are more flexible in their capabilities then the required components or the necessary technology is delivered to the plurality of user devices 35 by the communications services controller 1 to enable or enhance the plurality of user devices 35.

The user side of the system is made up of three functional areas, namely a user interface 50, a client technology applications 51 and an interface 52 to the server 2. The communications between the server 2 and the user 4 are identified by the arrow 55. The client's side components, namely the user interface 50, the client technology applications 51 and the interfaces to the server 52 generally interact with each other. However, this does not necessarily always have to be the case.

Additionally, some portions of the client technology applications 51, for example, may actually reside on the server, managed and controlled in some way by the communications services controller 1 with an interface to the user 4. Generally this depends on how powerful the plurality of user devices 35 is. If a user device 35 is relatively thin, obviously most of the technology resides in the communications services controller 1. The user interface 50 is a layer which provides the user with interaction with the communications services controller 1 and the system generally. It presents; the client technology applications and the communications services controller information through the interface to the server 52. Thus it delivers instructions to user 4.

Client technology applications 51 are those components of technology which need to run on the user side to enable specific abilities to the users. As mentioned already, they may already reside with the user or may be delivered to the user by the Iport server 2. Alternatively they may be third party or bespoke. An interface to the server 52 provides a layer of interaction to the Iport server 2. It provides the Iport server 2 with a method of talking to the client technology applications 51 and the user interface 50. It may also provide additional functionality such as securing the connection 55 between the user 4 and the Iport server 2. This arrow 55 is essentially the communications layer between the user 4 and the Iport server 2. This runs on top of the physical network resource, whether it be wireless, PSTN or Internet Protocol (I.P.). It generally consists of the necessary communications and protocols between the interface to the server 52 and the interface to the client 60.

The components of the Iport server 2 will reside over a multitude of physical separate servers running on a multitude of platforms 61 for example NT, Solaris, Linux, UNIX and so on. These platforms consist of the hardware and software required to enable the Iport server components whether they be directly residing in the Iport itself or those provided by a third party to function. The platform 61 directly connects to a business logic layer 62. It contains the intelligence to handle and manage any service provided by the server 2 and the users for that service within certain rules and privileges. This also contains the interface to the client user applications which may be simply the server half of the communications to the client. It may add a security function or actually include a portion of the user interface. There is illustrated the directory service 63 which stores most information pertaining to users, contacts, the services and rules to support the rules and privileges engines as described below. An additional database could be connected to part of this for data.

There is illustrated a plurality of arrows between the directory service 63 and business logic layer 62 and a variety of various systems 64 to 69 which represent various systems that provide functionality delivered by the system including conferencing for video application sharing 64, instant messenger 65, unified messaging 66, IP to PSTN 67, scheduling 68 and an auditing service for billing and reporting 69 which is in return connected to a billing system 75. There are also further services 71, platforms 71 and applications 72. The services 70 are shown as potential services and have not been identified as any particular service, similarly with the platforms 71 or the other applications 72 and thus this is simply another way of showing what the invention has previously been.

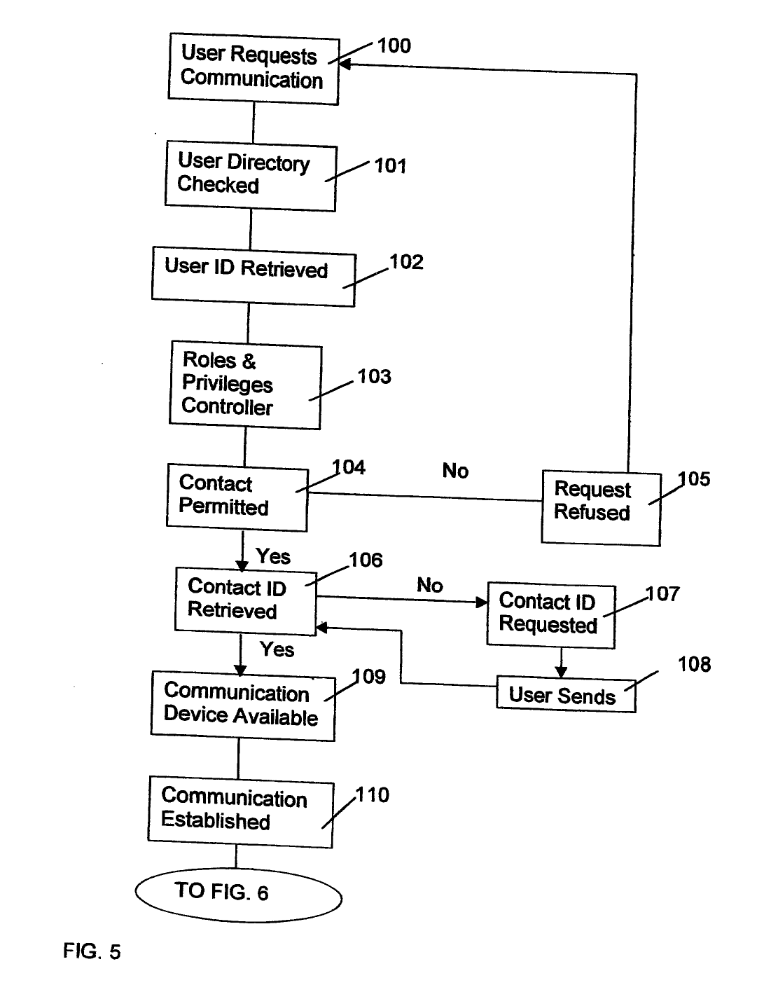

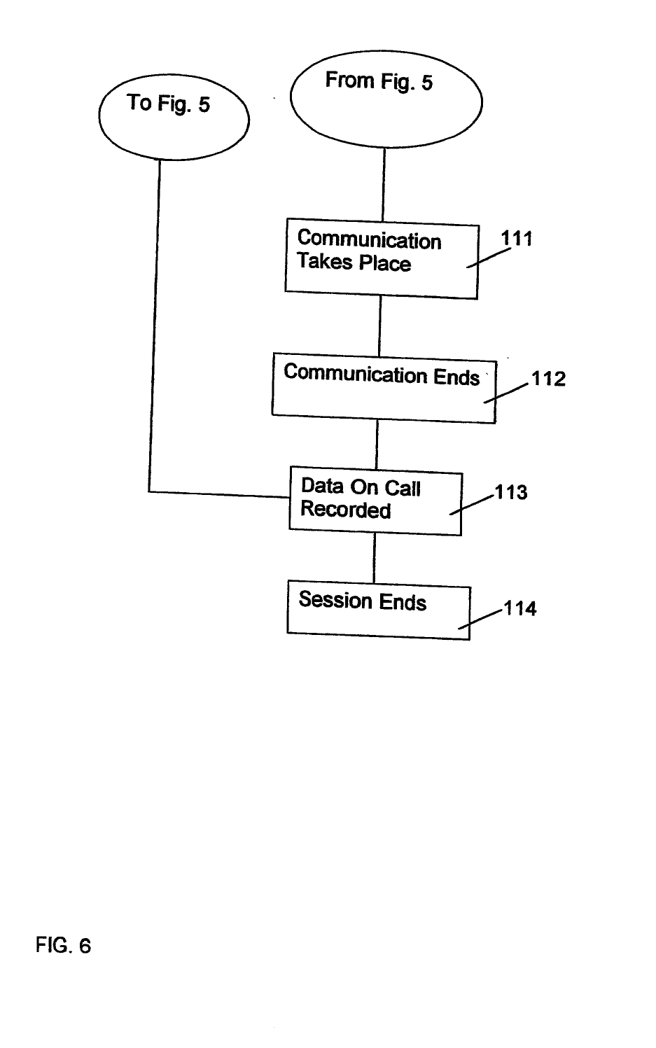

Referring to FIGS. 5 and 6, there is illustrated one way in which a client or user using a user device 4 can open communications with a contact device 5. In step 100, the user requests communication with the desired contact by downloading from a directory, the request for communication. The user directory is checked in step 101 and in step 102, the user ID is retrieved. In step 103, the roles and privileges controller is checked and in step 104 a message is sent to the user, denying the contact in step 105, in that the user is not permitted by the controller to make the necessary contact and this will be described in more detail later. Presuming that the contact is allowed, then in step 106, the contact ID is retrieved and presuming there is no contact ID, then in step 107, the contact ID is requested or obtained in some way, usually by requesting the user. In step 108, the user returns the contact ID to the contacts directory where the contact ID is then entered into the directory and the contacts ID is then sent to the communications device in step 109, where it is requested whether there is a communications device with the contact ID that the user can contact. In step 110, communications is established. In step 111, communications takes place and in step 112, communication ends. In step 113, the data on the call is recorded and is entered into the roles an privileges controller. In step 114, the session ends. This gives a very simplified view of how a communications takes place. What must be appreciated is that once the user requests a communications and the communication is permitted, all the other tasks are performed automatically for the user.

Essentially, the kernel of this invention is about who you communicate with, then how not vice versa. Essentially, the first point of contact or access for the user is the personal contacts directory service supplied by both the user directory and the contacts directory, as defined above. This provides a database for the storage and management of both business and personal contact information along with the business logic layer and is effectively the core of the invention in the sense that the information about a contact is integrated with the various applications and services in communications systems which can be, as explained, a simple system just as a normal voice communications, but could be something such as a messaging service or the like. Thus, if a particular user wishes to contact another user or indeed a contact separate from the system, the contacts directory is the tool whereby the user operates the system. In simple terms, the user effectively says, for example, “I wish to communicate with X via a video conference”. That is all the user requires. He selects the manner in which they wish to contact them, e.g. Joe Brown by email, voice, video, and so on. The controller takes over then and provides the communication subject to the roles and privileges that will be discussed below. The user does not know what technical tasks have been carried out in making the contact, for example, whether there is technological difficulties because the particular contact or user that the first user wishes to have a video conferences with, happens to operate a different system. It could be a different video system or a different messages system or whatever. The controller according to the present invention assumes that function, carries out all the work and there is effectively seamless communications between the two people. The user does not need to know how to operate any of the devices or how to make the contacts, it is all done for him or her.

Effectively, the user interacts with their own contacts list as the first action in initiating their communication. It is envisaged that the contacts list can be managed, grouped, sorted and filtered to suit the users needs. For example, it may be advisable to sort the contacts such that the favourite contacts appear first. It is envisaged that any contact may be easily added. The present invention is effectively a paradigm shift away from normal communications. Before, when dealing with a communication, the user has to choose the device to use, then operate the device according to the rules for that device and the communications system required such as selecting the contact, initiating the communication, and so on. In other words, effectively, what the user had to do was to have the “how” as it were of the communications, rather than the “who”. The present invention is a combination of a directory service and a business logic layer which effectively shifts this into reverse, allowing the user to choose who, and then the system takes care of the “how” and all the ancillary processes that can be additionally associated with the communication, rather than the user having to control all of this. Further, the Iport enablement of various communications devices e.g. mobile phone, PC etc, will make the choice of device irrelevant to the communications process.

Further, the present invention overcomes one of the major problems for most corporations and organisations, in controlling the actual communications and the contacts, namely, when some user can contact another user by implementing roles, rules and privileges. It is easiest to define this in relation to an organisation, but it will be appreciated that it can equally well be carried out for one individual. One individual might require that only various members of his or her family could use, for example, particular services for a limited period in every month. Thus, there would be certain restrictions placed on the use by that family member. However, this will become more apparent as the invention is described in more detail.

Essentially, the rules and privileges logic controller according to the present invention controls access to desired communications systems for specific users. These can either be the one user or sets of users. For example, it could simply be a means for defining a privilege as an access rule to a specified services provided on a specified communications system. For example, and this is purely an example, it might be decided that a certain group of people can only have access to video conferencing. Thus, for example, in relation to one particular communications system, the privilege could be within an organisation:

| | |
|---|---|
| Platinum | unlimited access |
| Status | |
| Gold Status | access between 7am and 7pm |
| Silver Status | access between 10am and 2pm |
| Bronze Status | access between 7am and 8am; 1pm-2pm; |
| | and 5 pm to 6 pm |
| No Status | no access |

The number and types of privilege should generally be kept to a minimum for simplicity. This type of system can then be provided for all users. Effectively, any category is a container for the particular communications system which, as mentioned already, may involve connection to a particular service such as email or probably more importantly, for example, a paid service that the company would not be particularly anxious to find all their employees consulting. Thus, management might be willing to allow certain personnel to download information from Reuters but would want to severely limit the amount of downloading that can take place. For example, presuming that the particular category or container had more than one application, then the specific privileges could be allocated to each individual application per user. This, for example, would accommodate individuals within a department being allowed only one application out of two, for example. Alternatively, the container of communications systems might be of similar communications systems, e.g. stock exchanges and you might permit an aggregate use not exceeding 10 hours per month to a user.

Essentially, privileges, in this invention, control the actions that a user can perform. There can be two types of privileges, namely, an administrative one, where you can control the actual users and then a usage one which can be based on either features or applications. It can be by way of controlling time or a budget restriction on a user per application or features. For example, starting off with a particular application, each application and feature which can be used, can have a set of privileges. They can be by way of the use, time limits on application usage or budget limits on application usage. It could by way of the budget limit for the application for usage of an application by an individual usage. As mentioned above, it could be by way of usage timers, in other words, that users can only use the particular application at various times. It could be, for example, incoming only or it could be specialist limitations such as, for example, on IP-PSTN, it could be by limited dialing codes, it could also be that in certain limited cases, there might be bandwidth limitations for a particular department or a particular organisation.

Further, there could be a limitation as to where such privileges can be implemented.

For example, one might have no problem whatsoever with a particular user using a particular application when within the company network, but management might be relatively unhappy with somebody accessing private information from outside the organisation or from an insecure device. However, it will be appreciated that once these privileges have been allocated to various users, the company or organisation is not in control of the manner in which the users operate the various communications systems and services available to them. Further, it is possible with the present invention, to get an accurate summary, over any particular period of time, of the usage of the various communications devices by the various employees of an organisation.

Essentially, it is a unified communications device providing one point of access for any communications device to any communications channel, while with the rules and privileges controlling the actual contacts that may be made. Also, not alone is it managing users but it will allow users to manage their contacts.

Another advantage of the present invention is that additional services can be added with no increase in complexity for the users.

The present invention provides a unified messaging system forming one of the communications systems. There is provided the one inbox offering a simple one point access store-forward-messaging solution. Users can use their desired email program, for example, Outlook, or even a web browser to access their full range of store-forward messaging communications. These include email (from multiple accounts or from one account), voicemail, fax which can be received, and generally SMS messaging from mobile phones or other phones.

A further feature of the present invention is that there is provided means to provide a private closed group for instant messaging which will allow personnel to hold meetings or even to ask brief questions without having to do anything more than contact the actual group and allow somebody in the group to answer the question. The advantage of this is that it will allow multiple participants to gauge in real time discussions saving the normal unmanaged mass emailing that normally hampers simple real time discussion via email. Thus, people will know to contact these targeted messaging groups, rather than consult all the emails they receive. It will be possible for companies therefore to limit email to quite definite groups and that all the rest of the email received would be effectively junk or irrelevant email. It does not, by any means, stop one to one communication, however, it is a method of ensuring that the real time discussion and more structured messaging can be obtained from email.

It is envisaged that with the instant messenger, it will be possible to synchronise with many popular instant messaging products including an MSN Messenger, AOL Instant Messenger, Yahoo Chat, IRC and ICQ. This will allow people to communicate with contacts that may use any number of these instant messenger products, the great advantage being that the person will not need to know what is the system the other person is using. There will be effectively seamless communication.

There can be provided an internet phone which provides a reduced cost telephone link from desktop to any PSTN phone number in the world for a fraction of the normal carrier cost. For example, it is envisaged that a user will not even have to dial the phone number of a contact but will simply click on the directory to phone and then the contact will be made directly.

The invention further provides conferencing service. Effectively, the conference service provides a virtual room. The meeting server will aggregate the internet phone stream to and from the participant computers. This saves bandwidth by only having one incoming and one outgoing data stream, irrespective of the number of participants. The only special hardware required is a sound card (shipped as standard on most PC's today) and for video, an inexpensive web-cam. Thus, for little additional cost, the present invention conferencing facility provides a video/voice conferencing environment. It is envisaged that the system can use multimedia conferencing and data sharing, allowing future versions to allow contacts who are not operating the present invention, participate in conferences initiated by those users connected to the communications service. Initially, it is envisaged that any standards compliant technologies suites may be easily integrated with the present conferencing system.

Further, the invention provides a collaboration device which allows the sharing of applications for collaborative working. In other words multiple people can edit the same document in real time. It is not necessary to have the application or document downloaded onto a particular user's machine nor indeed will the users need to be operating the same operating system. It is envisaged that the collaboration environment will allow annotation of the current file being worked on with each participant allocated some means by which others can see how that particular person has collaborated in the work. In one logical way, you could simply highlight, by means of different colours, the input of different workers.

As explained already, the present invention allows the use of various business efficiency tools which make the work interaction process easier.

It will be appreciated that the present invention allows control over users and groups of users through role and privilege management. This gives any organisation greater flexibility and simplicity in controlling the user communications environment. This administration facility allows the manager of a company to limit and control what applications and communications methods a user may access. It will also allow management to monitor users interactions with the system via the reporting option.

It will be appreciated that various aspects of the invention may be embodied on a computer that is running a program or program segments originating from a computer readable or usable medium, such medium including but not limited to magnetic storage media (e.g. ROMs, floppy disks, hard disks, etc.), optically readable media (e.g. CD-ROMs, DVDs, etc.) and carrier waves (e.g., transmissions over the internet). A functional program, code and code segments, used to implement the present invention can be derived by a skilled computer programmer from the description of the invention contained herein.

It will be appreciated therefore that a computerised program may be provided providing program instructions which, when loading into a computer, will constitute the means for organising and rearranging the traffic flow in accordance with the invention and that this computer program may be embodied on a record medium, a computer memory, a read only memory or carried on an electrical carrier signal.

In the specification the terms “comprise, comprises, comprised and comprising” or any variation thereof and the terms “include, includes, included and including” or any variation thereof are considered to be totally interchangeable and they should all be afforded the widest possible interpretation.

The invention is not limited to the embodiments hereinbefore described but may be varied in both construction and detail within the scope of the claims.

1. A communications services controller for a communications network comprising a plurality of communications systems connected to a network resource; a plurality of user devices connected to the services controller, the user services having a capability to use at least one of the communications systems; a plurality of contact devices connected to the network resource and having a capability to use at least one of the communications systems, some of the contact devices being additionally user devices, the services controller comprising:
(a) a user directory comprising:
a user identifier;
data on all communications systems available to the user including a unique identifier for each communications system, and access data to allow the user device access the available communications systems;
(b) a roles and privileges logic controller comprising means for controlling access to a desired communications system on a user requesting to use the communications system, the roles and privileges logic controller having means for storing access rules based on the roles and privileges allocated to the user, and means to provide access based on the said access rules;
(c) a contacts directory comprising a contacts identifier, data on each communications system available to the contact device, including a unique identifier for each communications system available to the contact device for use in the managed network resource;
(d) an intercommunications server having means for contacting and opening communications using a communications system connected to the network resource between a user device and a contacts device on receiving an access permitted signal, said intercommunications server having means to obtain the necessary access data for the user device from the user directory and for the contact device from the contacts directory.

2. A controller as claimed in claim 1, in which the intercommunications server comprises means for allowing a user device access more than one communications system simultaneously for contact with the one contact device.

3. A controller as claimed in claim 2, in which the intercommunications server comprises means for allowing a user device access more than one communications system simultaneously for contact with another contact device while communicating with a different contact device.

4. A controller as claimed in claim 2, in which the roles and privileges logic controller comprises means for storing a record of the access to a communications system obtained by a user during a preset period.

5. A controller as claimed in claim 2, in which the roles and privileges logic controller comprises:
means for defining a privilege as an access rule to a specified communications system;
means for defining a plurality of privileges; and
means to allocate at least one privilege to each user.

6. A controller as claimed in claim 2, in which the roles and privileges logic controller comprises:
means for defining a privilege as an access rule to a specified service provided on a specified communications systems;
means for defining a plurality of privileges; and
means to allocate at least one privilege to each user.

7. A controller as claimed in claim 2, in which the roles and privileges logic controller comprises:
means for defining a privilege as an access rule to a specified communications system;
means for defining a plurality of privileges;
means to allocate at least one privilege to each user and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

8. A controller as claimed in claim 2, in which the roles and privileges logic controller comprises:
means for defining a privilege as an access rule to a specified service provided on a specified communications systems;
means for defining a plurality of privileges;
means to allocate at least one privilege to each user and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

9. A controller as claimed in claim 2, comprising:
a conferencing server having means to allow a user device contact the server, and
means in the server to aggregate the data to and from each user device to provide a single incoming and outgoing data stream independent of the number of users.

10. A controller as claimed in claim 2, comprising a closed messaging device for the reception and storage of messages for nominated user devices.

11. A controller as claimed in claim 2, comprising a closed messaging device for the reception and storage of messages for nominated user devices and includes means to receive and store messages from disparate messaging services.

12. A controller as claimed in claim 2, comprising a unified messaging server having means for storing store-forward-messaging services.

13. A controller as claimed in claim 2, comprising a unified messaging server having means for storing store-forward-messaging services which comprises one or more of:-email; voicemail; fax received and SMS messages.

14. A controller as claimed in claim 2, comprising:
means to allow users access to view a document;
means to allow the user edit the document;
means to store the changes in the document due to editing by a user, said changes being identified by user.

15. A controller as claimed in claim 2 in which the network resource is the internet.

16. A controller as claimed in claim 2 in which the network resource is the extranet.

17. A controller as claimed in claim 2 in which the network resource is the intranet.

18. A controller as claimed in claim 2, in which the roles and privileges logic controller includes means to provide an access permitted signal and an access denied signal.

19. A controller as claimed in claim 1, in which the intercommunications server comprises means for allowing a user device access more than one communications system simultaneously for contact with another contact device while communicating with a different contact device.

20. A controller as claimed in claim 19, in which the roles and privileges logic controller comprises means for storing a record of the access to a communications system obtained by a user during a preset period.

21. A controller as claimed in claim 19, in which the roles and privileges logic controller comprises:
means for defining a privilege as an access rule to a specified communications system;
means for defining a plurality of privileges; and
means to allocate at least one privilege to each user.

22. A controller as claimed in claim 19, in which the roles and privileges logic controller comprises:
means for defining a privilege as an access rule to a specified service provided on a specified communications systems;
means for defining a plurality of privileges; and
means to allocate at least one privilege to each user.

23. A controller as claimed in claim 19, in which the roles and privileges logic controller comprises:
means for defining a privilege as an access rule to a specified communications system;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

24. A controller as claimed in claim 19, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

25. A controller as claimed in claim 19, comprising a closed messaging device for the reception and storage of messages for nominated user devices and includes means to receive and store messages from disparate messaging services.

26. A controller as claimed in claim 19, comprising a unified messaging server having means for storing store-forward-messaging services.

27. A controller as claimed in claim 19, comprising a unified messaging server having means for storing store-forward-messaging services and which comprises one or more of:- email; voicemail; fax received and SMS messages.

28. A controller as claimed in claim 19, comprising:
means to allow users access to view a document;
means to allow the user edit the document;
means to store the changes in the document due to editing by a user, said changes being identified by user.

29. A controller as claimed in claim 1, in which the roles and privileges logic controller comprises means for storing a record of the access to a communications system obtained by a user during a preset period.

30. A controller as claimed in claim 29, in which the roles and privileges logic controller comprises:
means for defining a privilege as an access rule to a specified communications system;
means for defining a plurality of privileges; and
means to allocate at least one privilege to each user.

31. A controller as claimed in claim 29, in which the roles and privileges logic controller comprises:
means for defining a privilege as an access rule to a specified service
provided on a specified communications systems;
means for defining a plurality of privileges; and
means to allocate at least one privilege to each user.

32. A controller as claimed in claim 29, in which the roles and privileges logic controller comprises:
means for defining a privilege as an access rule to a specified communications system;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

33. A controller as claimed in claim 29, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

34. A controller as claimed in claim 29, comprising a closed messaging device for the reception and storage of messages for nominated user devices and includes means to receive and store messages from disparate messaging services.

35. A controller as claimed in claim 29, comprising a unified messaging server having means for storing store-forward-messaging services.

36. A controller as claimed in claim 29, comprising a unified messaging server having means for storing store-forward-messaging services and which comprises one or more of:-email; voicemail; fax received and SMS messages.

37. A controller as claimed in claim 29, comprising:
means to allow users access to view a document;
means to allow the user edit the document;
means to store the changes in the document due to editing by a user, said changes being identified by user.

38. A controller as claimed in claim 1, in which the roles and privileges logic controller comprises:
means for defining a privilege as an access rule to a specified communications system;
means for defining a plurality of privileges; and
means to allocate at least one privilege to each user.

39. A controller as claimed in claim 38, in which the roles and privileges logic controller comprises:
means for defining a privilege as an access rule to a specified communications system;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

40. A controller as claimed in claim 38, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

41. A controller as claimed in claim 38, comprising a closed messaging device for the reception and storage of messages for nominated user devices and includes means to receive and store messages from disparate messaging services.

42. A controller as claimed in claim 38, comprising a unified messaging server having means for storing store-forward-messaging services.

43. A controller as claimed in claim 38, comprising a unified messaging server having means for storing store-forward-messaging services and which comprises one or more of:- email; voicemail; fax received and SMS messages.

44. A controller as claimed in claim 38, comprising:
means to allow users access to view a document;
means to allow the user edit the document;
means to store the changes in the document due to editing by a user, said changes being identified by user.

45. A controller as claimed in claim 1, in which the roles and privileges logic controller comprises:
means for defining a privilege as an access rule to a specified service provided on a specified communications systems;
means for defining a plurality of privileges; and
means to allocate at least one privilege to each user.

46. A controller as claimed in claim 45, in which the roles and privileges logic controller comprises:
means for defining a privilege as an access rule to a specified communications system;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

47. A controller as claimed in claim 45, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications
system traffic handling capabilities,
priority of access with respect to other users,
nature of contact which it is desired to communicate with.

48. A controller as claimed in claim 45, comprising a closed messaging device for the reception and storage of messages for nominated user devices and includes means to receive and store messages from disparate messaging services.

49. A controller as claimed in claim 45, comprising a unified messaging server having means for storing store-forward-messaging services.

50. A controller as claimed in claim 45, comprising a unified messaging server having means for storing store-forward-messaging services and which comprises one or more of:-email; voicemail; fax received and SMS messages.

51. A controller as claimed in claim 45, comprising:
means to allow users access to view a document;
means to allow the user edit the document;
means to store the changes in the document due to editing by a user, said changes being identified by user.

52. A controller as claimed in claim 1, in which the roles and privileges logic controller comprises:
means for defining a privilege as an access rule to a specified communications system;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications
system traffic handling capabilities,
priority of access with respect to other users,
nature of contact which it is desired to communicate with.

53. A controller as claimed in claim 52, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

54. A controller as claimed in claim 52, comprising a closed messaging device for the reception and storage of messages for nominated user devices and includes means to receive and store messages from disparate messaging services.

55. A controller as claimed in claim 52, comprising a unified messaging server having means for storing store-forward-messaging services.

56. A controller as claimed in claim 52, comprising a unified messaging server having means for storing store-forward-messaging services and which comprises one or more of:-email; voicemail; fax received and SMS messages.

57. A controller as claimed in claim 52, comprising:
means to allow users access to view a document;
means to allow the user edit the document;
means to store the changes in the document due to editing by a user, said changes being identified by user.

58. A controller as claimed in claim 1, in which the roles and privileges logic controller comprises:
means for defining a privilege as an access rule to a specified service provided on a specified communications systems;
means for defining a plurality of privileges;
means to allocate at least one privilege to each user; and in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

59. A controller as claimed in claim 58, comprising a closed messaging device for the reception and storage of messages for nominated user devices and includes means to receive and store messages from disparate messaging services.

60. A controller as claimed in claim 58, comprising a unified messaging server having means for storing store-forward-messaging services.

61. A controller as claimed in claim 58, comprising a unified messaging server having means for storing store-forward-messaging services and which comprises one or more of:-email; voicemail; fax received and SMS messages.

62. A controller as claimed in claim 58, comprising:
means to allow users access to view a document;
means to allow the user edit the document;
means to store the changes in the document due to editing by a user, said changes being identified by user.

63. A communications services controller for a communications network comprising a plurality of communications systems connected to a network resource; a plurality of user devices connected to the services controller, the user devices having a capability to use at least one of the communications systems; a plurality of contact devices connected to the network resource and having a capability to use at least one of the communications systems, some of the contact devices being additionally user devices, the services controller comprising:
(a) a user directory comprising:
a user identifier;
data on all communications systems available to the user including a unique identifier for each communications system, and access data to allow the user device access the available communications systems;
(b) a roles and privileges logic controller comprising:
means for defining a privilege as an access rule to a specified communications system;
means for defining a plurality of privileges;
means to allocate at least one privilege to each user;
means for storing access rules based on the roles and privileges allocated to the user; and
means to provide access based on the said access rules;
(c) a contacts directory comprising a contacts identifier, data on each communications system available to the contact device, including a unique identifier for each communications system available to the contact device for use in the managed network resource;
(d) an intercommunications server having means for contacting and opening communications using a communications system connected to the network resource between a user device and a contacts device on receiving an access permitted signal, said intercommunications server having means to obtain the necessary access data for the user device from the user directory and for the contact device from the contacts directory.

64. A controller as claimed in claim 63, in which the intercommunications server comprises means for allowing a user device access more than one communications system simultaneously for contact with the one contact device.

65. A controller as claimed in claim 63, in which the intercommunications server comprises means for allowing a user device access more than one communications system simultaneously for contact with another contact device while communicating with a different contact device.

66. A controller as claimed in claim 63, in which the roles and privileges logic controller comprises means for storing a record of the access to a communications system obtained by a user during a preset period.

67. A controller as claimed in claim 63, in which the roles and privileges logic controller comprises:
means for defining a privilege as an access rule to a specified communications system;
means for defining a plurality of privileges; and
means to allocate at least one privilege to each user.

68. A controller as claimed in claim 63, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

69. A controller as claimed in claim 63, comprising:
a conferencing server having means to allow a user device contact the server, and
means in the server to aggregate the data to and from each user device to provide a single incoming and outgoing data stream independent of the number of users.

70. A controller as claimed in claim 63, comprising a closed messaging device for the reception and storage of messages for nominated user devices and includes means to receive and store messages from disparate messaging services.

71. A controller as claimed in claim 63, comprising a unified messaging server having means for storing store-forward-messaging services.

72. A controller as claimed in claim 63, comprising a unified messaging server having means for storing store-forward-messaging services and which comprises one or more of:-email; voicemail; fax received and SMS messages.

73. A controller as claimed in claim 63, comprising:
means to allow users access to view a document;
means to allow the user edit the document;
means to store the changes in the document due to editing by a user, said changes being identified by user.

74. A communications services controller for a communications network comprising a plurality of communications systems connected to a network resource; a plurality of user devices connected to the services controller, the user devices having a capability to use at least one of the communications systems; a plurality of contact devices connected to the network resource and having a capability to use at least one of the communications systems, some of the contact devices being additionally user devices, the services controller comprising:
(a) a user directory comprising:
a user identifier;
data on all communications systems available to the user including a unique identifier for each communications system, and access data to allow the user device access the available communications systems;
(b) a roles and privileges logic controller comprising:
means for defining a privilege as an access rule to a specified service provided on a specified communications system:
means for defining a plurality of privileges;
means to allocate at least one privilege to each user;
means for storing access rules based on the roles and privileges allocated to the user;
means to provide access based on the said access rules;
(c) a contacts directory comprising a contacts identifier, data on each communications system available to the contact device, including a unique identifier for each communications system available to the contact device for use in the managed network resource;
(d) an intercommunications server having means for contacting and opening communications using a communications system connected to the network resource between a user device and a contacts device on receiving an access permitted signal, said intercommunications server having means to obtain the necessary access data for the user device from the user directory and for the contact device from the contacts directory.

75. A controller as claimed in claim 73, in which the intercommunications server comprises means for allowing a user device access more than one communications system simultaneously for contact with the one contact device.

76. A controller as claimed in claim 73, in which the intercommunications server comprises means for allowing a user device access more than one communications system simultaneously for contact with another contact device while communicating with a different contact device.

77. A controller as claimed in claim 73, in which the roles and privileges logic controller comprises means for storing a record of the access to a communications system obtained by a user during a preset period.

78. A controller as claimed in claim 73, in which the roles and privileges logic controller comprises:
means for defining a privilege as an access rule to a specified communications system;
means for defining a plurality of privileges; and
means to allocate at least one privilege to each user.

79. A controller as claimed in claim 73, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

80. A controller as claimed in claim 73, comprising:
a conferenc1ing server having means to allow a user device contact the server, and
means in the server to aggregate the data to and from each user device to provide a single incoming and outgoing data stream independent of the number of users.

81. A controller as claimed in claim 73, comprising a closed messaging device for the reception and storage of messages for nominated user devices and includes means to receive and store messages from disparate messaging services.

82. A controller as claimed in claim 73, comprising a unified messaging server having means for storing store-forward-messaging services.

83. A controller as claimed in claim 73, comprising a unified messaging server having means for storing store-forward-messaging services and which comprises one or more of:-email; voicemail; fax received and SMS messages.

84. A controller as claimed in claim 73, comprising:
means to allow users access to view a document;
means to allow the user edit the document;
means to store the changes in the document due to editing by a user, said changes being identified by user.

85. A method in a communications network of controlling and facilitating the use by users of user devices for at least one communications system connected to a network resource, and contact devices for at least one communications system connected to the network resource comprising the initial steps of:
allocating to and storing a user identifier for each user;
collecting and storing data on each communications system available to the user;
collecting and storing access data to allow a user device, operated by the user, access each available communications system;
allocating to and storing by means of privileges rules to the user, the terms and conditions under which access to each communications system is permitted;
allocating to and storing a contact identifier to a contact;
collecting and storing contact access data to allow a user device access the contact on a contact device and on a user requesting access to a contact, the steps are performed of:
consulting the privileges rules and on the access to the communications system being permitted, retrieving the contact access data and using the access data to connect the user device to the contact device.

86. A method as claimed in claim 85, in which, on the user requesting to be connected to a contact device, the access data to allow the user device to communicate with the contact is not available, the user first collects the necessary access data for storage.

87. A method as claimed in claim 86, in which the user device is connected to the contact device by more than one communications system.

88. A method as claimed in claim 86, in which the user device is connected to two different contact devices.

89. A method as claimed in claim 86, in which there is stored a record of the access to a communications system obtained by a user during a preset period.

90. A method as claimed in claim 86, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

91. A computer program comprising program instructions for causing a computer to perform the method of claim 86.

92. A computer program comprising program instructions embodied on a record medium for causing a computer to perform the method of claim 86.

93. A computer program comprising program instructions stored in a computer memory for causing a computer to perform the method of claim 86.

94. A computer program comprising program instructions embodied in a read only memory for causing a computer to perform the method of claim 86.

95. A computer program comprising program instructions on an electrical signal carrier for causing a computer to perform the method of claim 86.

96. A method as claimed in claim 85, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

97. A method as claimed in claim 96, in which, on the user requesting to be connected to a contact device, the access data to allow the user device to communicate with the contact is not available, the user first collects the necessary access data for storage.

98. A method as claimed in claim 96, in which the user device is connected to the contact device by more than one communications system.

99. A method as claimed in claim 96, in which the user device is connected to two different contact devices.

100. A method as claimed in claim 96, in which there is stored a record of the access to a communications system obtained by a user during a preset period.

101. A method as claimed in claim 96, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

102. A computer program comprising program instructions for causing a computer to perform the method of claim 96.

103. A computer program comprising program instructions embodied on a record medium for causing a computer to perform the method of claim 96.

104. A computer program comprising program instructions stored in a computer memory for causing a computer to perform the method of claim 96.

105. A computer program comprising program instructions embodied in a read only memory for causing a computer to perform the method of claim 96.

106. A computer program comprising program instructions on an electrical signal carrier for causing a computer to perform the method of claim 96.

107. A method in a communications network in which the initial steps have been performed of:
allocating to and storing a user identifier for each user;
collecting and storing data on each communications system available to the user;
collecting and storing access data to allow a user device, operated by the user, access each available communications system;
allocating to and storing by means of privileges rules to the user, the terms and conditions under which access to each communications system is permitted;
allocating to and storing a contact identifier to a contact;
collecting and storing contact access data to allow a user device access the contact on a contact device and on a user requesting access to a contact, the method comprising:
consulting the privileges rules and on the access to the communications system being permitted, retrieving the contact access data and using the access data to connect the user device to the contact device.

108. A method as claimed in claim 107, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

109. A method as claimed in claim 108, in which, on the user requesting to be connected to a contact device, the access data to allow the user device to communicate with the contact is not available, the user first collects the necessary access data for storage.

110. A method as claimed in claim 108, in which the user device is connected to the contact device by more than one communications system.

111. A method as claimed in claim 108, in which the user device is connected to two different contact devices.

112. A method as claimed in claim 108, in which there is stored a record of the access to a communications system obtained by a user during a preset period.

113. A method as claimed in claim 108, in which the privilege is one or more of:
total duration of use within a specified time period,
usage between specified times during any day,
monetary limits over a specified time limit,
incoming use only,
user device limitation,
number of users already provided with the privilege communications system traffic handling capabilities,
priority of access with respect to other users,
nature of contact which it is desired to communicate with.

114. A computer program comprising program instructions embodied on a record medium for causing a computer to perform the method of claim 108.

115. A computer program comprising program instructions stored in a computer memory for causing a computer to perform the method of claim 108.

116. A computer program comprising program instructions embodied in a read only memory for causing a computer to perform the method of claim 108.

117. A computer program comprising program instructions on an electrical signal carrier for causing a computer to perform the method of claim 108.

118. A method as claimed in claim 107, in which, on the user requesting to be connected to a contact device, the access data to allow the user device to communicate with the contact is not available, the user first collects the necessary access data for storage.

119. A method as claimed in claim 107, in which the user device is connected to the contact device by more than one communications system.

120. A method as claimed in claim 107, in which the user device is connected to two different contact devices.

121. A method as claimed in claim 107, in which there is stored a record of the access to a communications system obtained by a user during a preset period.

122. A computer program comprising program instructions for causing a computer to perform the method of claim 107.

123. A computer program comprising program instructions embodied on a record medium for causing a computer to perform the method of claim 107.

124. A computer program comprising program instructions stored in a computer memory for causing a computer to perform the method of claim 107.

125. A computer program comprising program instructions embodied in a read only memory for causing a computer to perform the method of claim 107.

126. A computer program comprising program instructions on an electrical signal carrier for causing a computer to perform the method of claim 107.
